(19) United States
(12) Patent Application Publication
(10) Pub. No.: US 2013/0030858 A1
(43) Pub. Date: Jan. 31, 2013

(54) DYNAMICALLY FACILITATING PROJECT ASSEMBLY

(71) Applicants: Monika Gupta, New Delhi (IN); Debdoot Mukherjee, West Bengal (IN); Vibha Singhal Sinha, New Delhi (IN); LiangJie Zhang, Cortlandt Manor, NY (US); Nianjun Zhou, Danbury, CT (US)

(72) Inventors: Monika Gupta, New Delhi (IN); Debdoot Mukherjee, West Bengal (IN); Vibha Singhal Sinha, New Delhi (IN); LiangJie Zhang, Cortlandt Manor, NY (US); Nianjun Zhou, Danbury, CT (US)

(73) Assignee: INTERNATIONAL BUSINESS MACHINES CORPORATION, Armonk, NY (US)

(21) Appl. No.: 13/598,330

(22) Filed: Aug. 29, 2012

Related U.S. Application Data
(63) Continuation of application No. 13/192,565, filed on Jul. 28, 2011.

(51) Int. Cl. G06Q 10/06

(52) U.S. Cl. 705/7.23; 705/7.12

(57) ABSTRACT

Methods and arrangements for dynamically facilitating project assembly. A project plan with a chosen set of plan components is submitted and a cloud portal is queried for information on chosen plan components. Information on the chosen plan components is received from the cloud portal. Plan recommendations are generated based on the received information, and a recommended plan is selected.

### CROSS REFERENCE TO RELATED APPLICATION

This application is a continuation of U.S. patent application Ser. No. 13/192,565, entitled METHODS AND SYSTEMS FOR DYNAMICALLY FACILITATING PROJECT ASSEMBLY, filed on Jul. 28, 2011, which is incorporated by reference in its entirety.

### BACKGROUND

Generally, in project management and execution, it can be very difficult to change or adjust the association resources in alignment with changing requirements. A custom application development typically starts from a standard project management tooling environment, but in today's project management and execution environment, it is very difficult to sync together the change of project requirements and associated resources with work breakdown structures.

### BRIEF SUMMARY

In summary, one aspect of the invention provides a method comprising: submitting a project plan with a chosen set of plan components; querying a cloud portal for information on the chosen plan components; receiving from the cloud portal information on the chosen plan components; generating plan recommendations based on the received information; and selecting a recommended plan.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 depicts a cloud computing node.

FIG. 2 depicts a cloud computing environment.

FIG. 3 depicts abstraction model layers.

FIG. 4 schematically illustrates a system architecture for facilitating project assembly.

FIG. 5 schematically illustrates a process for facilitating project assembly.

FIG. 6 sets forth a process more generally for dynamically facilitating project assembly.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-Demand Self-Service:

A cloud consumer can unilaterally provision computing capabilities, such as server time and network storage, as needed automatically without requiring human interaction with the service's provider.

Broad Network Access:

Capabilities are available over a network and accessed through standard mechanisms that promote use by heterogeneous thin or thick client platforms (e.g., mobile phones, laptops, and PDAs).

Resource Pooling:

The provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid Elasticity:

Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured Service:

Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS):

The capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS):

The capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS):

The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private Cloud:

The cloud infrastructure is operated solely for an organization. It may be managed by the organization or a third party and may exist on-premises or off-premises.

Community Cloud:

The cloud infrastructure is shared by several organizations and supports a specific community that has shared concerns (e.g., mission, security requirements, policy, and compliance considerations). It may be managed by the organizations or a third party and may exist on-premises or off-premises.

Public Cloud:

The cloud infrastructure is made available to the general public or a large industry group and is owned by an organization selling cloud services.

Hybrid Cloud:

The cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

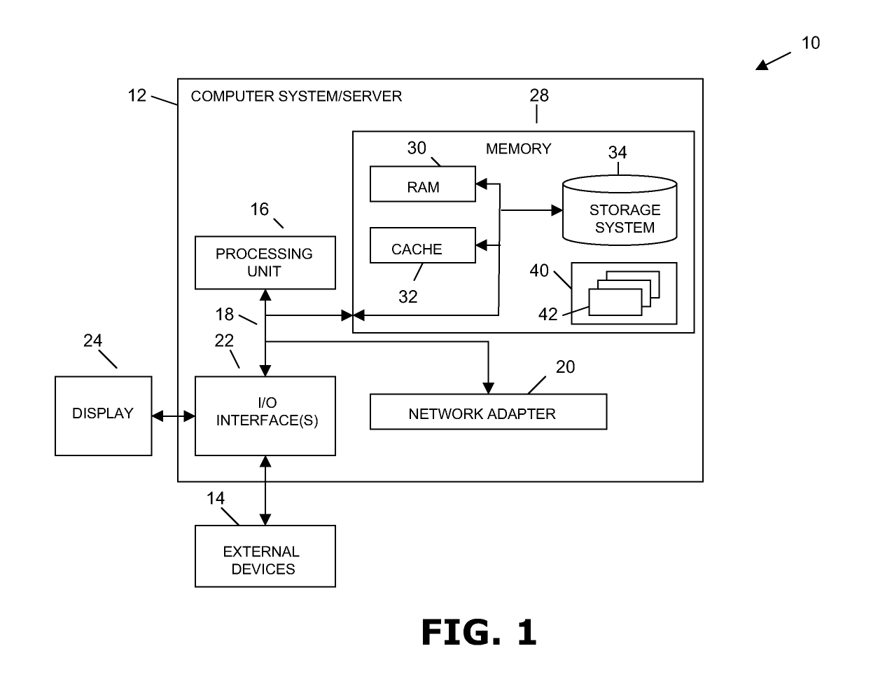

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

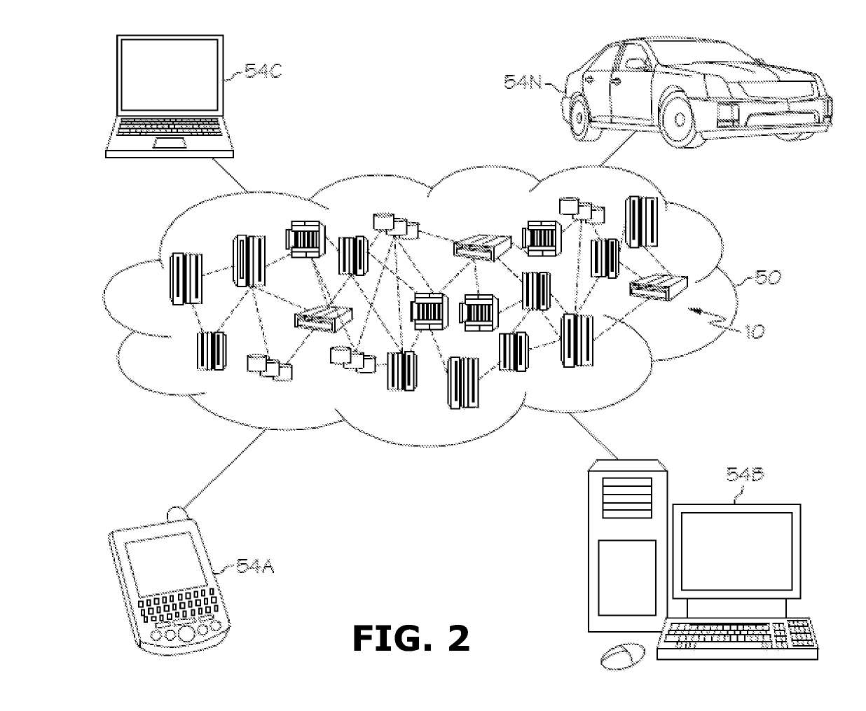

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

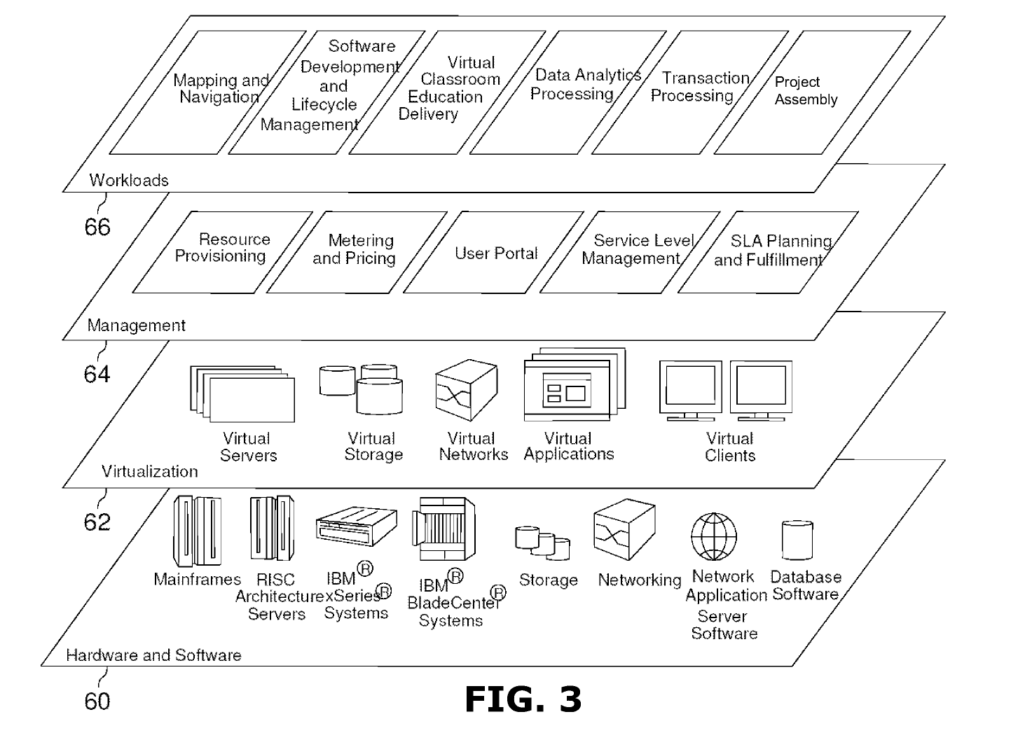

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and project assembly.

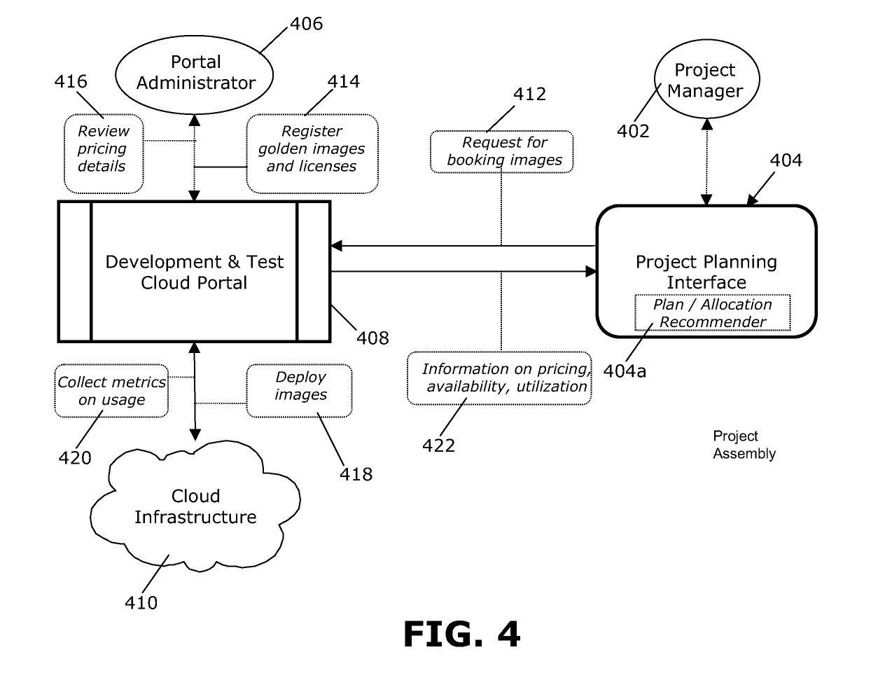

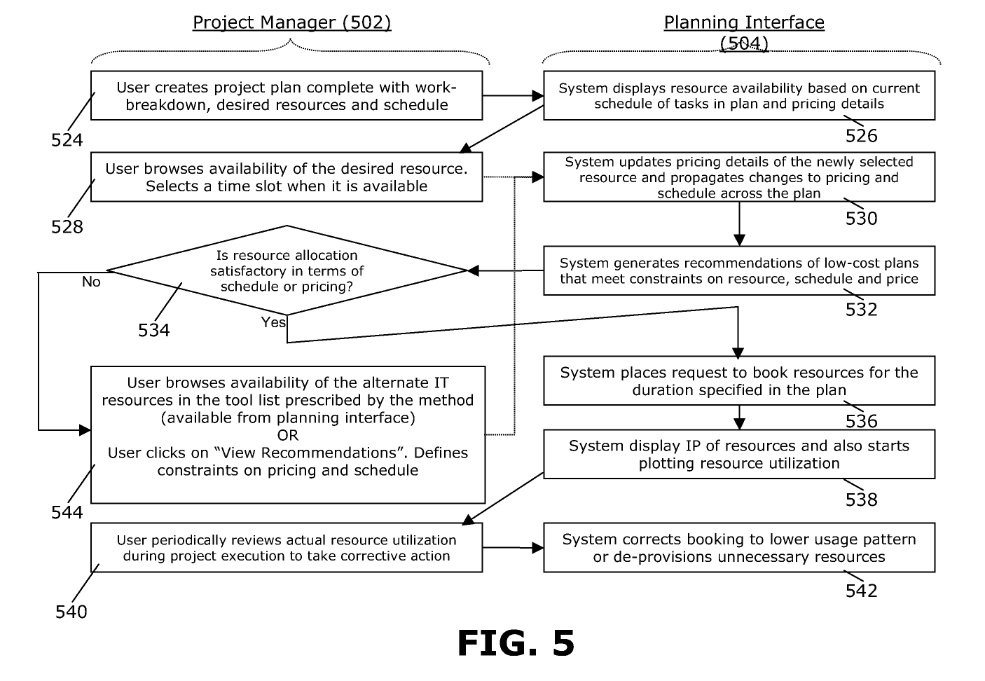

The disclosure now turns to FIGS. 4 and 5. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 4 and 5 can be performed or utilized by way of a processing unit or units and system memory such as those indicated, respectively, at 16 and 28 in FIG. 1, whether on a server computer, a client computer, a node computer in a distributed network, or any combination thereof.

To facilitate easier reference, in advancing from FIG. 4 to and through FIG. 5, a reference numeral is advanced by a multiple of 100 in indicating a substantially similar or analogous component or element with respect to at least one component or element found in at least one earlier figure among FIGS. 4 and 5.

In accordance with at least one embodiment of the invention, a dynamic project assembly feature in cloud infrastructure is employed to align changes in resources and scheduling with the changes in a project execution plan. To this end, a connection between resource requirements and consumption patterns is built into various levels of work breakdown structures (WBS's). Further, a method is broadly contemplated herein for maximizing resource usage in project execution, to readily accommodate dynamically changing requirements.

In accordance with at least one embodiment of the invention, the process of launching a project is optimized in a cloud environment, wherein: resources are identified including hardware, software, platforms, project members and workers in addition to operations with resources such as provisioning and deprovisioning of an application in cloud environment; a project's WBS and associated metrics are identified; resource consumption patterns are identified at various level of WBS; an association between WBS and resources is optimized based on cost function and constraints in a cloud environment; and manual adjustment and validation based on the optimization algorithm is permitted.

Accordingly, as shown schematically in FIG. 4, a project manager 402 is in communication with a project planning interface 404, itself including a plan/allocation recommender 404a. Interface 404 is in communication with a development and test cloud portal 408, with which a portal administrator 406 is in communication. Portal 408, for its part, is in communication with a cloud infrastructure 410 in a manner that will be better understood here below. Generally, the development and test cloud portal 408 exposes services that allow booking, provisioning and de-provisioning of resources in a cloud environment.

Generally, in accordance with at least one embodiment of the invention, project manager 402 or another user, via interface 404, sends out a request 412 for booking images to portal 408. In the context of at least one embodiment of the invention, images can be defined as those resources (hardware and/or software) that are used or needed to carry out a project. As will be further appreciated herein, information on their availability is employed in creating a project plan or schedule.

In accordance with at least one embodiment of the invention, images, for their part, are deployed (418) on the cloud 410 on demand from the portal 408. Usually, a set of preconfigured images called templates or “golden images” are kept aside on the cloud 410, and embody standardized configurations of hardware/software commonly used in different projects. In response to a new provisioning request, one or more golden images are cloned to create new instances of images on the cloud 410 that have the exact configuration present in the golden images. Thus, a portal administrator 406 can register golden images to meet different kinds of resource needs, configure pools of licenses (414), and input pricing details 416 for the resources. To this last point, when new instances are provisioned on the cloud 410 for use in projects, available licenses are assigned to the software present in these instances and thereafter the project is charged per their time of usage according to registered pricing policies (as conveyed via the details 416).

In accordance with at least one embodiment of the invention, portal 408, also collects metrics on image usage (408) to be stored as historical data and also to provide onward to interface 404. As such, responsive to request 412, portal 408 provides information in pricing, availability and utilization of images (422) back to interface 404 which, via recommender 404a, can provide to project manager 402 (or another user) a recommended plan for utilizing or allocating images.

FIG. 5 schematically illustrates a method in accordance with at least one embodiment of the invention. As shown, several steps (524, 528, 534, 544 and 540) are undertaken by a project manager 502 and several (526, 530, 532, 536, 538 and 542) are undertaken by a planning interface 504. (Reference to a “user” in FIG. 5 can be understood to be inclusive of the project manager 502 and/or conceivably at least one other individual at the project manager's end.)

As shown, in accordance with at least one embodiment of the invention, a user creates a project plan, including a WBD (work breakdown structure), desired resources and schedule (524). Via planning interface 504, the system displays resource availability based on a current schedule of tasks in plan and also displays the pricing details (526) of available resources. Thence, the user browses the availability of the desired resource and selects a time slot when the resource is available (528). At planning interface 504, the system updates pricing details of the newly selected resource and propagates changes to pricing and schedule across the plan. (530) (Essentially, such change propagation can take place, e.g., when the price of one resource changes so as to change the total sum of individual prices.) Thence, the system generates recommendations of low-cost plans that meet constraints on resources, scheduling and pricing (532); this may be undertaken by a plan/allocation recommender such as that indicated at 404a in FIG. 4.

In accordance with at least one embodiment of the invention, project manager 502 then decides (534) whether resource allocation is satisfactory in terms of schedule and/or pricing. If yes, the system (via planning interface 504) places a request to book resources for the duration specified in the plan (536), and also displays the IP address of resources and starts to plot resource utilization (538). Thereafter, during project execution, the user periodically receives information on actual resource utilization (540), which may warrant corrective action. If corrective action is needed, the system (via planning interface 504) can correct the booking to a lower usage pattern and/or deprovision unnecessary or superfluous resources (542).

In accordance with at least one embodiment of the invention, if the answer at query 534 is “no”, then (544) the user browses availability of the alternate IT resources in a prescribed tool list (e.g., available from a planning interface 504) or the user issues a command such as “view recommendations” and defines constraints on price and schedule. Thence, the process reverts to step 530.

It will be appreciated that, by way of positive consequences, in accordance with at least one embodiment of the invention, a project assembly can be integrated with the result of resource optimization, task management can be aligned with the reuse of resources with the project assembly can be exploited and maximized.

It can also be appreciated that, in accordance with at least one embodiment of the invention, there is employed a cross-environment sharing framework (e.g., for multiple scenarios that can involve images, portal, and a real-time clock) to define key components of a project assembly (e.g., project, phase, plan, and tasks in XML structure) to capture a relationship among those components. This system can be used to maximize while keeping a project running well within a delivery time frame.

It can further be appreciated that, in accordance with at least one embodiment of the invention, there is broadly contemplated herein the management of a lifecycle of application development, a dynamic reallocation of resources based on need, and a cost reduction framework for reusing or eliminate existing resources. WBS is dynamically adjusted in parallel and sequential acts to balance the project delivery time and resource constraints.

In accordance with at least one embodiment of the invention, it can be considered that three portions are employed: a static portion, a planning portion and an execution portion. In the static portion, which can correspond to step 524 in FIG. 5, work package templates are defined (e.g., in an XML or relational database). A needed staffing curve and needed resources (e.g., computer resources, time considerations) are then defined.

In a planning portion, in accordance with at least one embodiment of the invention, and which can correspond to steps 526-538 in FIG. 5, team members are defined and the project is created with a work package and sub-plans. Staff and computer resources are then assigned to the work package, computer resources required time/effort are then computed and, as needed, the plan is adjusted.

In an execution portion, in accordance with at least one embodiment of the invention, and which can correspond to steps 540 and 542 in FIG. 5, to the extent needed or warranted, computer resources are provisioned, job assignments of team members are changed, and then computer resources are deprovisioned.

It can be appreciated that a solution as described hereinabove, in accordance with at least one embodiment of the invention, combines a dynamic project assembly feature with dynamic resource provisioning and deprovisioning to maximize resource usage and to provide a tradeoff between staffing and scheduling constraints. To this end, a WBS, in accordance with at least one embodiment of the invention, provides a hierarchical, tree-like organization of planned work in a project. Metrics on effort, resource utilization and cost are rolled up at each level in the WBS, while estimates of desired schedules, resource requirements and costs are also predicted at each level.

In accordance with at least one embodiment of the invention, semi-automatic re-adjustment of resource consumption at each level in WBS is provided. To this end, suggested automatic adjustments are made on the basis of local and global optimization of at least one project parameter (such as project cost, schedule, resource utilization, etc.) after meeting hard constraints on the rest of the parameters. This permits a margin for the manual override of any parameter at any node in WBS tree, whereupon the optimization problem can be resolved anew to make adjustments for values in cost, schedule, utilization, etc., in the rest of the WBS tree.

In accordance with at least one embodiment of the invention, assigned and free resources are visualized at each level of the WBS, and the reuse of freed-up resources, that have met constraints introduced along the WBS, is managed. Further, the WBS can be optimized and adjusted to compliment the needs of project changes, as governed by an optimization algorithm.

In accordance with at least one variant embodiment of the invention, a plan recommender such as that indicated at 404a in FIG. 4 can implement a constraint solving algorithm, which generates project plans that satisfy constraints on resource availability (obtained from a cloud portal such as that indicated at 408 in FIG. 4) and user-defined constraints on pricing and schedule. Accordingly, in this implementation, a constraint satisfaction problem is set up as a triple <X, D, C> where:
X is a set of variables. For every task in the plan, a variable is created to capture information on the IT resource assigned to it. In accordance with a non-restrictive example, such variables can include: (Resource-Type, DateProvision, DateDe-provision, Price). Here, Resource-Type subsumes various details of an image (e.g., set of software, version, licenses, usage duration, support model).
D represents the domain of values, as derived from the pricing and resource availability information gathered from the cloud portal
For C, different kinds of constraints are defined. For example, these can include:
Limit on number of resources of a particular type that may be provisioned at any point of time—dictated by number of licenses available for the software or availability of support staff.
   Constraints for start & end date for every task obtained by resolving task dependencies defined in the project plan.
   User-defined constraints for start and end dates of specific tasks (may be hard constraints or soft constraints with defined penalties)
   User-defined constraints for price of specific tasks or groups of tasks (e.g., these could be hard constraints or soft constraints with defined penalties).
   Limit on total price (entered by the user at the time of generating a recommendation).
   Maximum deviation possible from current plan, as defined by the user at level of tasks or groups of tasks.

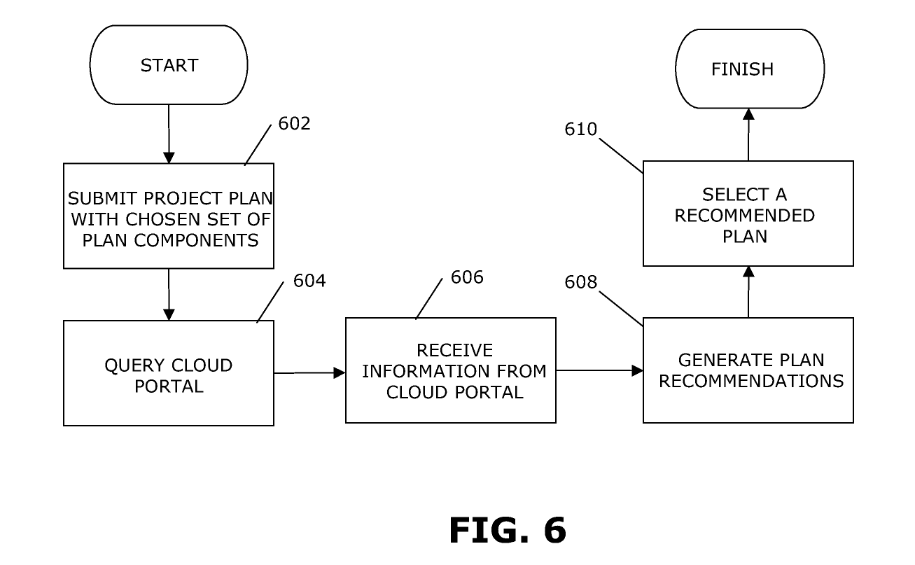

FIG. 6 sets forth a process more generally for dynamically facilitating project assembly, in accordance with at least one embodiment of the invention. It should be appreciated that a process such as that broadly illustrated in FIG. 6 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 6 can be performed by way a processing unit or units and system memory such as those indicated, respectively, at 16 and 28 in FIG. 1.

As shown in FIG. 6, a project plan with a chosen set of plan components is submitted (602) and a cloud portal is queried for information on the chosen plan components (604). Information on the chosen plan components is received from the cloud portal (606). Plan recommendations are generated based on the received information (608), and a recommended plan is selected (610).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
submitting a project plan with a chosen set of plan components;
querying a cloud portal for information on the chosen plan components;
receiving from the cloud portal information on the chosen plan components;
generating plan recommendations based on the received information; and
selecting a recommended plan.

2. The method according to claim 1, further comprising booking plan resources corresponding to the recommended plan.

3. The method according to claim 1, further comprising:
choosing alternative plan components; and
adjusting the recommended plan based on the alternative plan components.

4. The method according to claim 1, wherein the chosen plan components include a project schedule.

5. The method according to claim 1, wherein the information on plan components includes information on available resources.

6. The method according to claim 1, wherein the information on plan components includes information on at least one image used in an application development project.

7. The method according to claim 6, wherein the at least one image comprises at least one taken from the group consisting of: at least one hardware resource; at least one software resource.

8. The method according to claim 1, wherein the received information includes information received from a cloud infrastructure.

9. The method according to claim 1, further comprising:
executing the selected plan;
reviewing actual resource utilization during execution; and
selectably readjusting the plan during execution.

10. The method according to claim 9, wherein said readjusting comprises at least one taken from the group consisting of: reducing a usage pattern; deprovisioning at least one resource.

11. The method according to claim 1, wherein said selecting comprises accepting a recommended plan outright, and thereupon prompting a resource booking for a duration specified in the accepted plan.

12. The method according to claim 1, wherein said selecting comprises: rejecting the recommended plans; and
at least one taken from the group consisting of: choosing alternative plan components; submitting constraints on plan components

13. The method according to claim 1, wherein the plan recommendations include low-cost plan recommendations.
